(19) United States
(12) Patent Application Publication
(10) Pub. No.: US 2023/0266164 A1
(43) Pub. Date: Aug. 24, 2023

(54) SPECTROSCOPIC DEVICE, SPECTROMETRY DEVICE, AND SPECTROSCOPIC METHOD

(71) Applicant: Nippon Telegraph and Telephone Corporation, Tokyo (JP)

(72) Inventors: Sohan Kawamura, Tokyo (JP); Yurina Tanaka, Tokyo (JP); Takashi Sakamoto, Tokyo (JP); Yuichi Akage, Tokyo (JP); Masahiro Ueno, Tokyo (JP); Soichi Oka, Tokyo (JP)

(21) Appl. No.: 18/005,265

(22) PCT Filed: Jul. 15, 2020
(86) PCT No.: PCT/JP2020/027470

§ 371 Date: Jan. 12, 2023

(51) Int. Cl. G01J 3/02; G01J 3/18; G01J 3/32

(52) U.S. Cl. CPC G01J 3/021; G01J 3/18; G01J 3/32

(57) ABSTRACT

A spectroscopic device includes a first optical element for wavelength-dispersing the light, a second optical element for converging the light which has been wavelength-dispersed, a light deflector for changing a trajectory of the converged light, the light deflector being of a transmission type and having an electro-optical effect, a drive power supply that applies a voltage to the light deflector, light receiver that detects at a predetermined position the light of which the trajectory has been changed, and a process unit that derives the wavelength of the detected light from the voltage.

### CROSS-REFERENCE TO RELATED APPLICATIONS

This application is a national phase entry of PCT Application No. PCT/JP2020/027470, filed on Jul. 15, 2020, which application is hereby incorporated herein by reference.

### TECHNICAL FIELD

The present invention relates to a spectroscopic device and method capable of achieving a high-speed operation and miniaturization.

### BACKGROUND

A spectroscopic device is used in a fluorescence spectrum measurement device, a fluorescence microscope, an absorptiometer, and the like, and is applied to material analysis, environmental measurement, and the like. For example, the fluorescence spectrum measurement device spectrally disperses light emitted from a sample irradiated with ultraviolet light or the like to measure a correlation between a wavelength of the light and light intensity.

A spectroscopic device is required to be miniaturized for high-speed operation and on-site use in fluorescence measurement of a substance in a fluid. For example, Patent Literature 1 discloses a technique related to miniaturization of a spectroscopic device.

### CITATION LIST

### Patent Literature

Patent Literature 1: JP 4645173 A.

### SUMMARY

### Technical Problem

The spectroscopic device disclosed in Patent Literature 1 includes a diffraction grating for dispersing wavelengths and a plurality of reflectors, and requires a complicated configuration and a mechanical drive unit. Since an operation speed depends on the drive unit, a larger drive unit is required to improve the operation speed. This restricts miniaturization of a casing of the device.

As described above, the spectroscopic device of the related art has a problem in that it is difficult to achieve a high-speed operation and miniaturization.

### Solution to Problem

In order to solve the above problem, according to embodiments of the present invention, there is provided a spectroscopic device for dispersing light, including a first optical element for wavelength-dispersing the light; a second optical element for converging the light which has been wavelength-dispersed; a light deflector for changing a trajectory of the converged light, the light deflector being of a transmission type and having an electro-optical effect, and changes a trajectory of the converged light; a drive power supply that applies a voltage to the light deflector; a light receiver that detects at a predetermined position the light of which the trajectory has been changed; and a process unit that derives the wavelength of the detected light from the voltage.

According to embodiments of the present invention, there is provided a spectroscopic method of dispersing light by using a transmission-type light deflector having an electro-optical effect, the spectroscopic method including a step of wavelength-dispersing the light; a step of converging the light which has been wavelength-dispersed; a step of applying a voltage to the light deflector to change a trajectory of the converged light; a step of detecting light of which the trajectory has been changed at a predetermined position; and a step of deriving the wavelength of the detected light from the voltage.

### Advantageous Effects of Embodiments of Invention

According to embodiments of the present invention, it is possible to provide a spectroscopic device, a spectrometry device, and a method capable of achieving a high-speed operation and miniaturization.

### BRIEF DESCRIPTION OF THE DRAWINGS

FIG. 1 is a diagram illustrating a configuration of a spectrometry device according to a first embodiment of the present invention.

FIG. 2 is a schematic view of a periphery of light deflector and a light receiver in a spectroscopic device according to the first embodiment of the present invention.

FIG. 3 is a flowchart illustrating a spectroscopic method according to the first embodiment of the present invention.

FIG. 4 is a diagram illustrating an example of a fluorescence spectrum measured by the spectrometry device according to the first embodiment of the present invention.

FIG. 5 is a diagram illustrating a configuration of a spectrometry device according to a second embodiment of the present invention.

FIG. 6 is a diagram for describing an operation of a spectroscopic device according to the second embodiment of the present invention.

### DETAILED DESCRIPTION OF ILLUSTRATIVE EMBODIMENTS

### First Embodiment

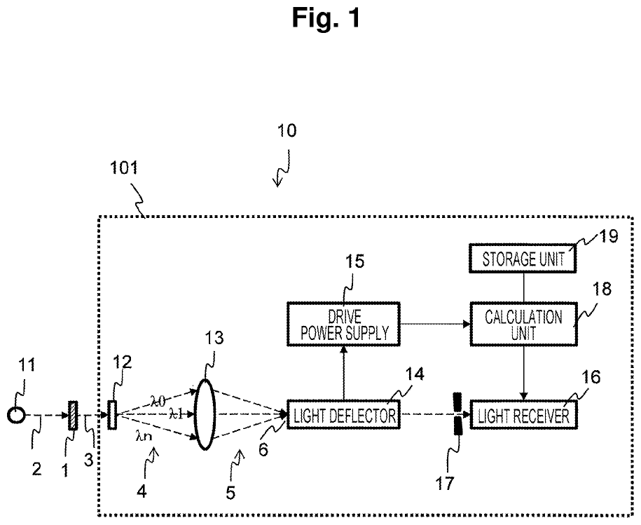

A spectroscopic device and a spectrometry device according to a first embodiment of the present invention will be described with reference to FIGS. 1 to 4.

### Configurations of Spectrometry Device and Spectroscopic Device

FIG. 1 illustrates a configuration of a spectrometry device 10 according to a first embodiment. The spectrometry device 10 includes a light source 11 and a spectroscopic device 101. The spectroscopic device 101 includes an optical element (hereinafter, referred to as a “first optical element”.) 12, an optical element (hereinafter, referred to as a “second optical element”.) 13, a light deflector 14, a drive power supply 15, a light receiver 16, a pin hole 17, and a process unit 18.

The light source 11 emits ultraviolet light 2 having a wavelength of 400 nm to 440 nm to irradiate a sample 1.

The first optical element 12 is of a transmission type and wavelength-disperses, and is, for example, a prism or a diffraction grating. Light 3 such as fluorescence emitted from the sample 1 is incident to the first optical element 12.

The second optical element 13 converges the light which has been wavelength-dispersed by the first optical element 12, is of a transmission type and does not wavelength-disperse, and is, for example, a lens.

The light deflector 14 is of a transmission type, and controls light 5 converged by the second 13 and incident from an incidence port 6 to change a trajectory of the light 5. The drive power supply 15 drives the light deflector 14.

The light receiver 16 detects the light transmitted through the light deflector 14 via the pin hole 17.

The process unit 18 derives the wavelength of the incident light from a voltage of the drive power supply 15, and acquires an applied voltage dependency of the wavelength. A spectroscopic spectrum is acquired on the basis of the applied voltage dependency of the wavelength and an intensity detected by the light receiver 16.

The storage unit 19 stores the applied voltage dependency of the wavelength acquired by the process unit 18. Measurement data may also be stored.

In the present embodiment, potassium niobate tantalate (KTa₁₋ₓ,NbₓO₃, hereinafter referred to as “KTN”) having an electro-optical effect is used for the transmission-type light deflector 14. The electro-optical effect is a phenomenon in which a refractive index of a substance changes when a voltage is applied.

In the spectroscopic device 101, the light 5 transmitted through the light deflector 14 is subjected to refractive index modulation and deflected in the light deflector 14, and a trajectory of the light 5 is changed and guided to the light receiver 16. As a result, the light 5 can be guided to the light receiver 16 fixed at a predetermined position and having a simple configuration.

Therefore, when the configuration of the present embodiment using KTN for the light deflector 14 is used, it is possible for the light receiver to detect the light 5 which has been wavelength-dispersed and converged for each wavelength without requiring a large number of optical elements or mechanical devices.

As described above, the spectrometry device 10 and the spectroscopic device 101 according to the present embodiment can be miniaturized and operated at a high speed by using KTN for the light deflector 14. A detailed operation principle will be described below.

### Operations of Spectrometry Device and Spectroscopic Device

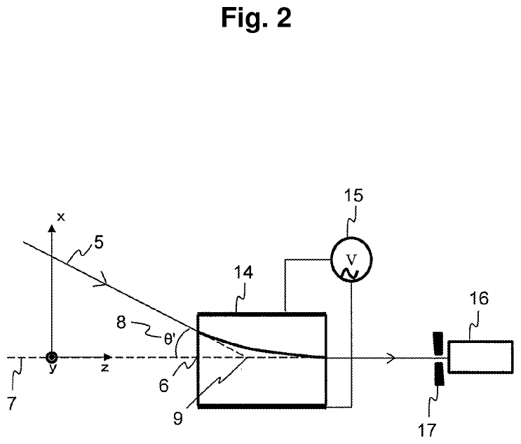

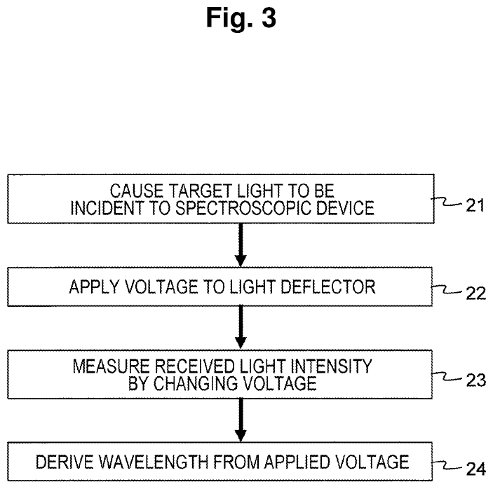

FIG. 2 illustrates a configuration of a periphery of the light deflector 14 and the light receiver 16 in the spectroscopic device 101 according to the present embodiment. FIG. 3 is a flowchart illustrating a spectroscopic method according to the present embodiment.

The light deflector 14 and the light receiver 16 are disposed in parallel to a horizontal plane such that an emission port of the light deflector 14 and an incidence port (light receiving window) of the light receiver 16 are on substantially the same optical axis 7. Therefore, an angle θ′ 8 at which the fluorescence 3 from the sample is transmitted through the first optical element 12 and the second optical element 13 and is incident to the light deflector 14 as the light 5 is an incidence angle with respect to the horizontal direction.

Hereinafter, “substantially the same” includes completely the same, and includes a case where there is a slight difference, for example, a case where there is a difference of about 2° to 3° or a difference of about 0.2 to 0.3 mm from the optical axis 7. In a case where such a difference is included, this difference leads to a measurement error. Therefore, “substantially the same” includes a case where there is a difference from the optical axis 7 within a range in which a measurement error is allowed.

First, a measurement target (sample) 1 is irradiated with the ultraviolet light 2 from the light source 11. The sample 1 absorbs the ultraviolet light 2 and emits the fluorescence 3.

Next, the fluorescence 3 is incident to the spectroscopic device 101, that is, the first optical element 12 for wavelength-dispersing (step 21). The fluorescence 3 is transmitted through the first optical element 12, subjected to wavelength-dispersion, and emitted as the light 4.

In the light 4, an output angle varies depending on a wavelength. As a result, the light 4 is incident to different positions of the second optical element 13 for the respective wavelengths.

Next, in the second optical element 13, the light 4 incident to the different position for each wavelength is transmitted through the second optical element 13, converged, and incident to the light deflector 14 as the light 5. As a result, the light 5 is incident to the light deflector 14 at a different incidence angle θ′ 8 for each wavelength.

Here, the light 5 is incident from the incidence port 6 of the light deflector 14 and converged on a focal point 9 on an optical axis (z axis) 7. The focal point 9 is located inside the light deflector 14.

The light 5 incident to the light deflector 14 is incident to the optical axis (z axis) 7 at the angle θ′ 8. As described above, the incidence angle θ′ 8 varies depending on a wavelength of the light 5. That is, the incidence angle θ′ 8 depends on the wavelength of the light 5. In a case where no voltage is applied to the light deflector 14, a trajectory of the light 5 hardly changes and is not guided to the light receiver 16.

Next, a voltage is applied to the light deflector 14 by the drive power supply 15. By applying the voltage, a trajectory of the light 2 is changed and thus an angle at which the light 2 is emitted is changed (step 22).

KTN is used for the light deflector 14. KTN has an electro-optical effect, and a refractive index of KTN changes when a voltage is applied.

Here, KTN causes a Kerr effect in which a refractive index changes in proportion to the square of an applied voltage. In particular, KTN has a large relative permittivity, and thus causes a large Kerr effect (Koichiro Nakamura, Jun Miyazu, Yuzo Sasaki, Tadayuki Imai, Masahiro Sasaura, and Kazuo Fujiura, “Space-charge-controlled electro-optic effect: Optical beam deflection by electro-optic effect and space-charge-controlled electrical conduction”, J. Appl. Phys. 104, 013105 (2008)).

Therefore, as represented in the following Equation (1), the light 5 incident to the KTN light deflector 14 can be emitted at an angle θ with respect to the optical axis (z axis) 7, and the angle θ changes in proportion to the square of an applied voltage. In other words, the light 5 incident at the angle θ′ 8 can be emitted in the direction of the optical axis (z axis) 7.

$$Equation 1$$

$$θ ≅ L \frac{d}{dx} Δ n ( x ) = - \frac{9}{8} {n}^{3} {s}_{ij} \frac{L}{d} {E}_{0}^{2} \qquad ( 1 )$$

Here, L is a length in the direction of the optical axis (z axis) of the light deflector 14, and Δn(x) is a refractive index change amount along the x axis orthogonal to the optical axis (z axis) and parallel to the paper surface. In addition, n is a refractive index of KTN, sᵢⱼ is an electro-optical coefficient, d is a length in the x axis direction in FIG. 2 (that is, a thickness of the KTN crystal), and E₀ is an electric field when no space charge effect occurs in the KTN crystal and depends on an applied voltage.

Here, it is necessary to consider that the refractive index n of KTN depends on a wavelength of the light 5 when a trajectory of the light 5 incident to the light deflector 14 is changed at a different angle depending on the wavelength.

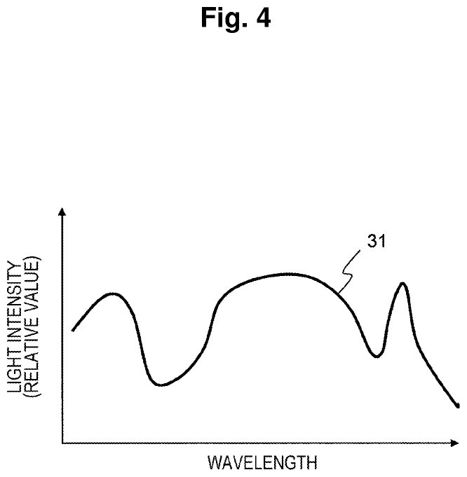

Next, when the voltage is changed, the trajectory of the light 5 is changed to a trajectory in the optical axis direction, and the light 5 is introduced into the light receiver 16 through the pin hole 17 provided on the z axis. Therefore, when a received light intensity is measured by changing the voltage, a spectrum 31 is observed as illustrated in FIG. 4 (step 23).

Here, a wavelength on the horizontal axis (x axis) in FIG. 4 is derived from a voltage applied to an optical modulator (step 24). For example, a wavelength can be derived from an applied voltage by acquiring the applied voltage dependency of the wavelength of incident light in advance.

For example, by measuring an applied voltage when light with a predetermined wavelength is incident to the spectroscopic device 101 and detected by the light receiver 16, and measuring the applied voltage by changing the wavelength of the incident light, the applied voltage dependency of the wavelength of the incident light can be acquired.

The applied voltage dependency of the wavelength of the incident light acquired in advance is stored and collated with the applied voltage at the time of measurement. As a result, the wavelength is derived from the applied voltage.

Here, since the KTN light deflector 14 can change a deflection angle following the AC voltage of 200 kHz, an angle can be measured at a high speed (about 0.01 milliseconds).

In the spectroscopic device 101, since the light 5 can be introduced into the light receiver 16 by the light deflector 14, the light receiver 16 may be small.

The light receiving window of the light receiver 16 is determined by a diameter of the pin hole 17. The diameter of the pin hole 17 may be changed according to a wavelength region to be measured. For example, in a case where the wavelength region to be measured is 400 nm to 1000 nm, the diameter of the pin hole 17 may be about 10 μm.

As described above, according to the spectroscopic device 101 of the present embodiment, since the small light deflector 14 and the small light receiver 16 are used without requiring a rotation mechanism of the optical element, the spectroscopic device 101 can be miniaturized, and a distance from the light source to the light receiver in the spectrometry device 10 can be reduced to about 100 mm to 150 mm.

As described above, the spectrometry device 10 and the spectroscopic device 101 according to the present embodiment can perform spectroscopy at a high speed with a simple configuration, and the device can be miniaturized.

### Second Embodiment

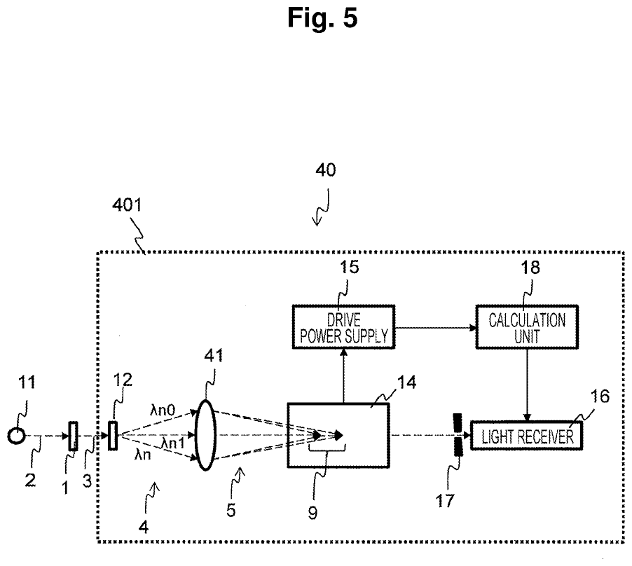

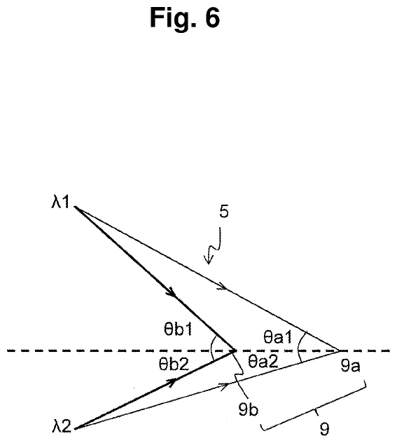

A spectrometry device and a spectroscopic device according to a second embodiment of the present invention will be described with reference to FIGS. 5 and 6.

FIG. 5 is a schematic view of a spectrometry device 40 and a spectroscopic device 401 according to the present embodiment. The spectroscopic device 401 has a configuration substantially similar to that of the spectroscopic device 101 according to the first embodiment, and includes a variable focus lens 41 in front of the incidence port of the light deflector 14 (light source side of incident light).

In the spectroscopic device 401, a wavelength resolution can be changed by changing a position of the focal point 9 with the variable focus lens 41.

FIG. 6 illustrates a position of the focal point 9 of the light 5 in the light deflector 14 in order to describe an operation of the spectroscopic device 401 according to the present embodiment.

In the spectroscopic device 401, as an incidence angle θ1 to θ2 corresponding to a measurement wavelength region λ1 to λ2 becomes smaller, an incidence angle (a unit incidence angle, that is, |λ2-λ1|/|θ2-θ1|) corresponding to the unit wavelength becomes smaller. Therefore, if the unit incidence angle becomes smaller than the accuracy with which the incidence angle can be detected, the wavelength resolution decreases.

On the other hand, as the incidence angle θ1 to θ2 corresponding to the measurement wavelength region λ1 to λ2 becomes larger, the incidence angle corresponding to the unit wavelength becomes larger, and thus the wavelength resolution is improved.

For example, as illustrated in FIG. 6, in a case where a position of the focal point 9 is measured as 9a with respect to the wide wavelength region λ1 to λ2, the incidence angle is θa1 to θa2. On the other hand, if the position of the focal point 9 is 9b, the incidence angle increases to θb1 to θb2, and thus the wavelength resolution is improved.

As described above, in the spectroscopic device 401, a wavelength resolution can be determined by changing a position of the focal point 9 with the variable focus lens 41 according to measurement conditions such as a measurement wavelength region in consideration of a measurement time.

In the spectroscopic device 401, the wavelength resolution can be improved by about 20% at the maximum by changing the position of the focal point according to the measurement conditions such as the measurement wavelength region.

According to the spectrometry device 40 and the spectroscopic device 401 of the present embodiment, spectroscopy can be performed at a high speed with a simple configuration, the device can be miniaturized, and a wavelength resolution can be changed.

### First Example

An example of fluorescence spectrum measurement using the spectroscopic device according to the embodiment of the present invention will be described as a first example.

In the present example, a measurement target (sample) may be any of an individual, a liquid, and a gas. N samples have different components (for example, different fluorescent substances are contained) in different states (individuals, liquids, and gases), are each independently held, and are disposed stationary on a plane perpendicular to the optical axis.

For these samples, the light deflector is operated at 200 kHz by using the fluorescence spectrum measuring device according to the present example, and spectrometry is performed on these samples. As a result, a fluorescence spectrum can be measured in 0.01 seconds for one sample.

Since the fluorescence from each sample is wavelength-dispersed and is incident to the light deflector at different angles, if positions of the disposed samples are ascertained, a fluorescence spectrum can be distinguished and measured for each sample.

As described above, the spectrometry can be performed collectively for N samples, and the spectrometry can be performed for about 0.01×N seconds for N samples. For example, 100 samples can be measured in 1 second.

The fluorescence spectrum measurement device according to the present example does not require a mechanical drive unit unlike in the device of the related art, and can thus perform spectrometry at a high speed.

### Second Example

A second example of fluorescence spectrum measurement using the spectroscopic device according to the embodiment of the present invention will be described.

In the present example, a measurement target (sample) may be any of an individual, a liquid, and a gas. N samples have different components (for example, different fluorescent substances are contained) in different states (individuals, liquids, and gases), are each independently held, and are moved at a constant speed in a plane perpendicular to the optical axis. For example, the fluorescence spectrum measurement device according to the present example is fixed, and a plurality of samples are moved on a conveyor such as a belt conveyor, and are sequentially subjected to measurement.

For these samples, the light deflector is operated at 200 kHz by using the fluorescence spectrum measuring device according to the present example, and spectrometry is performed on these samples. As a result, a fluorescence spectrum can be measured in 0.01 seconds for one sample.

Therefore, when the sample is passed under the measurement device at intervals of 0.01 seconds, the measurement can be performed for about 0.01×N seconds for N samples. For example, 100 samples can be measured in 1 second.

The fluorescence spectrum measurement device according to the present example does not require a mechanical drive unit unlike in the device of the related art, and can thus perform spectrometry at a high speed.

Since the spectroscopic device according to the embodiment of the present invention does not require a mechanical drive unit, the entire device can be miniaturized to about 150 mm from the light source to the light receiver, and can thus be applied to on-site measurement or measurement in a mobile environment.

In the embodiments according to the present invention, an example in which KTN is used for the light deflector has been described, but the present invention is not limited thereto. Even if barium titanate (BaTiO₃: BT), potassium tantalate (KTaO₃: KT), or strontium titanate (SrTiO₃: ST) is used as a substance having a Kerr effect that is an electro-optical effect, the substantially same effect is achieved.

The light deflector according to the embodiment of the present invention is not limited to KTN as long as a substance has an electro-optical effect, and the substantially same effect is achieved even when a substance having a Pockel's effect in which a refractive index changes in proportion to an applied voltage is used. As substances having the Pockel's effect, lithium niobate (LiNbO₃, hereinafter referred to as “LN”.) may be used, or lead lanthanum zirconate titanate ((Pb₁₋ₓLaₓ)(Zr_{y}Ti_{1-y})₁₋ₓ/4O₃: PLZT) may be used.

In the light deflector according to the embodiment of the present invention, a substantially similar effect can be obtained even in an acousto-optical element using LN or the like.

An example in which a transmission type optical element is used for an optical element for wavelength-dispersing in the embodiments according to the present invention has been described, but a reflection type optical element such as a reflection type diffraction grating may be used.

An example in which a transmission type optical element is used as an optical element for converging light in the embodiments according to the present invention has been described, but a reflection type optical element such as a condenser mirror may be used.

In the embodiments of the present invention, an example in which light transmitted through a measurement target (sample) is dispersed has been described, but light reflected by a measurement target (sample) may be dispersed.

In the embodiments according to the present invention, an example in which a fluorescence spectrum is acquired by using the spectroscopic device has been described, but not only the fluorescence spectrum but also a spectrum of absorbed light or reflected light may be acquired.

In the embodiments according to the present invention, the example of the spectrometry device including the spectroscopic device and the light source has been described, but only the spectroscopic device may be used. Reflected light of natural light such as sunlight from a measurement target may be dispersed, and in this case, a light source is not required.

In the embodiments according to the present invention, an example in which the light deflector, the light receiver, and the plurality of light deflectors are disposed on the substantially same optical axis parallel to the horizontal direction has been described, but the present invention is not limited thereto. The constituents may be disposed on an optical axis that is not parallel to the horizontal direction and forms a predetermined angle w. In this case, an angle may be calculated in consideration of the difference w between angles from the horizontal direction.

The light deflector and the light receiver do not have to be disposed on the substantially same optical axis. In this case, an angle may be calculated in consideration of a difference from the optical axis in the disposition of the light deflector and the light receiver.

The light deflector may be disposed in a range in which the emitted light can be incident to the light receiver.

In the embodiments of the present invention, examples of the structure, the dimension, the material, and the like of each constituent have been described in the configuration of the spectroscopic device, the method, and the like, but the present invention is not limited thereto. It is sufficient that functions of the spectroscopic device and the method according to embodiments of the present invention are exhibited to achieve effects.

### INDUSTRIAL APPLICABILITY

Embodiments of the present invention can be applied to measurement of a fluorescence spectrum emitted from a fluorescent substance, light absorption spectrum of a substance or the like, and the like.

### REFERENCE SIGNS LIST

10 Spectroscopic device
11 Light source
12 First optical element
13 Second optical element
14 Light deflector
15 Drive power supply
16 Light receiver
17 Pin hole
18 Process unit
19 Storage unit.

1-6. (canceled)

7. A spectroscopic device for dispersing light, comprising:
a first optical element configured to wavelength-disperse the light;
a second optical element configured to converge the light which has been wavelength-dispersed;
a light deflector configured to change a trajectory of the light which has been converged, the light deflector being of a transmission type and having an electro-optical effect;
a drive power supply configured to apply a voltage to the light deflector;
a light receiver configured to detect at a predetermined position the light of which the trajectory has been changed; and
a processor configured to derive, from the voltage, a wavelength of the light detected by the light receiver.

8. The spectroscopic device according to claim 7, further comprising:
a storage device configured to store voltage dependency of the wavelength measured in advance, wherein the processor is configured to collate the voltage with the voltage dependency of the wavelength to derive the wavelength of the light detected by the light receiver.

9. The spectroscopic device according to claim 7, wherein:
the second optical element is a variable focus lens.

10. The spectroscopic device according to claim 7, wherein:
the light deflector includes potassium niobate tantalate.

11. A spectrometry device comprising:
a spectroscopic device comprising:
a first optical element configured to wavelength-disperse the light;
a second optical element configured to converge the light which has been wavelength-dispersed;
a light deflector configured to change a trajectory of the light which has been converged, the light deflector being of a transmission type and having an electro-optical effect;
a drive power supply configured to apply a voltage to the light deflector;
a light receiver configured to detect at a predetermined position the light of which the trajectory has been changed; and
a processor configured to derive, from the voltage, the wavelength of the light detected by the light receiver; and
a light source.

12. The spectrometry device according to claim ii, wherein:
the spectroscopic device further comprises a storage device configured to store voltage dependency of the wavelength measured in advance; and
the processor is further configured to collate the voltage with the voltage dependency of the wavelength to derive the wavelength of the light detected by the light receiver.

13. The spectrometry device according to claim ii, wherein:
the second optical element is a variable focus lens.

14. The spectrometry device according to claim ii, wherein:
the light deflector includes potassium niobate tantalate.

15. A spectroscopic method of dispersing light by using a transmission-type light deflector having an electro-optical effect, the spectroscopic method comprising:
wavelength-dispersing the light;
converging the light which has been wavelength-dispersed;
changing, by applying a voltage to a light defector, a trajectory of the light which has been converged;
detecting at a predetermined position the light of which the trajectory has been changed; and
deriving, from the voltage, a wavelength of the light which has been detected at the predetermined position.

16. The spectroscopic method according to claim 15, further comprising:
storing a voltage dependency of the wavelength measured in advance, wherein deriving, from the voltage, the wavelength comprises collating the voltage with the voltage dependency of the wavelength to derive the wavelength of the light detected at the predetermined position.

17. The spectroscopic method according to claim 15, wherein:
converging the light comprises converging the light with a variable focus lens.

18. The spectroscopic method according to claim 15, wherein:
the light deflector includes potassium niobate tantalate.
